(19) United States
(12) Patent Application Publication
(10) Pub. No.: US 2024/0399704 A1
(43) Pub. Date: Dec. 5, 2024

(54) MULTILAYER COOLING ASSEMBLIES FOR THERMAL MANAGEMENT

(71) Applicant: Alexium, Inc., Greer, SC (US)

(72) Inventors: Robert N. Brookins, Simpsonville, SC (US); Jonas Larue, Bolling Springs, SC (US)

(21) Appl. No.: 18/690,700

(22) PCT Filed: Sep. 8, 2022
(86) PCT No.: PCT/US2022/076141

§ 371 Date: Mar. 8, 2024

Related U.S. Application Data
(60) Provisional application No. 63/241,980, filed on Sep. 8, 2021.

(51) Int. Cl. B32B 5/24; A41D 13/005; B32B 5/02; B32B 5/18; B32B 5/26; F41H 1/02

(52) U.S. Cl. CPC B32B 5/245; A41D 13/0053; B32B 5/02; B32B 5/18; B32B 5/26; F41H 1/02; B32B 2307/302; B32B 2307/3065; B32B 2307/7376; B32B 2437/00; B32B 2535/00; B32B 2571/02

(57) ABSTRACT

Described herein are multilayer cooling assemblies that include at least two compressible layers and a heat-dissipating layer, which imparts beneficial thermal management properties without a significant adverse effect on flexibility and/or cushioning properties, so the assemblies remain suitable for use in protective garments, athletic equipment, performance apparel, and other clothing where they will contact a wearer and where wearer comfort is important.

### CROSS-REFERENCES TO RELATED APPLICATIONS

This application claims priority to and the benefit of U.S. Provisional Application No. 63/241,980, filed on Sep. 8, 2021, entitled “MULTILAYER COLLING ASSEMBLIES FOR THERMAL MANAGEMENT” hereby incorporated by reference in its entirety and for all purposes.

### FIELD

Described herein are multilayer cooling assemblies for personal thermal management and clothing including the cooling assemblies, where the cooling assemblies increase the rate of body heat transfer to the environment as compared to clothing without the cooling assemblies.

### BACKGROUND

Thermal management properties have become desirable in textile-based products used for protective garments, athletic accessories, clothing, and other wearables that contact individuals. These items can absorb and retain heat from the individual, which can create a sense of discomfort for the individual.

Efforts to improve the thermal properties of protective clothing, such as body armor vests, include using a phase change material (“PCM”). PCMs have a high heat of fusion and are capable of storing and releasing energy at known, consistent temperatures. The amount of heat absorbed by a PCM, and thus the effect of the PCM on the heat transfer rate of a material, depends on the mass of PCM present, which is limited by technical and practical considerations, such as the weight of the finished garment, application technique, and desired tactile properties (e.g., how the finished material will feel to an individual). Any microencapsulation increases the effective mass of the PCM without proportionate increase in the amount of heat that can be absorbed and also causes a super cooling effect. PCM-based products have been found to be inadequate for thermal management of body armor vests due to the short-lived cooling effect. Within less than an hour of wearing a PCM treated vest, the cooling effect is exhausted and no further benefit can be had.

Other efforts to improve the thermal properties of vests include using textiles and foams that promote air flow. This approach has some benefit because it does provide a means of dissipating heat into the environment. The benefits of such technologies, however, have only shown marginal value.

It is desirable to develop textile-based assemblies that have better thermal management properties. These assemblies would be useful in many applications, such as incorporated into protective garments, athletic accessories, and apparel. Ideally, the cooling assemblies would reduce the individual's sense of thermal discomfort for an extended period of time.

### SUMMARY

Multilayer cooling assemblies described herein are useful in protective garments, athletic accessories, performance apparel, and other clothing, to increase the individual's sense of thermal comfort. The cooling assemblies include at least one heat-dissipating layer, which includes a conductive film or foil. Optionally, the cooling assemblies include at least one textile layer that includes a phase change material. In use, the conductive film/foil transports heat from a wearer's body to an external environment without compromising flexibility, comfort, or performance-related properties of the garment into which the cooling assembly is incorporated.

### BRIEF DESCRIPTION OF THE DRAWINGS

FIGS. 1A-IC are schematic representations of a garment that includes a multilayer cooling assembly consistent with the present disclosure.

FIGS. 2A-2B are schematic representations of cross-sectional views of multilayer cooling assemblies consistent with the present disclosure.

FIGS. 3A-3H are schematic representations of heat-dissipating layers consistent with the present disclosure.

FIGS. 4A and 4B are schematic representations of a multilayer cooling assembly consistent with the present disclosure.

FIGS. 5A and 5B are schematic representations of a multilayer cooling assembly consistent with the present disclosure.

FIGS. 6A-6E are representations of multilayer cooling assemblies consistent with the present disclosure.

FIG. 7 is a graph showing average heat flux for the multilayer cooling assemblies shown in FIGS. 6A-6E.

### DETAILED DESCRIPTION

Provided herein are multilayer cooling assemblies for use in protective garments, athletic equipment, performance apparel, and other clothing, which for ease of reference are individually and collectively referred to herein as “garments.” The multilayer cooling assemblies include at least two compressible layers and at least one heat-dissipating layer between the two compressible layers. In some examples, the multilayer cooling assemblies include at least two textile layers and at least one heat-dissipating layer between the two textile layers. In other examples, however, the compressible layers can be textile-based layers and/or foam-based layers. The heat-dissipating layer imparts beneficial thermal management properties to the cooling assembly without adversely affecting the flexibility, comfort, and mechanical properties provided by the garment into which it is incorporated. Thus, assemblies described herein are suitable for use in garments where they will contact a wearer (directly or indirectly through other clothing) and where flexibility, comfort, and mechanical properties of the garment are important for wearer comfort and/or safety. The heat-dissipating layer facilitates active dissipation of body heat from a wearer's body, through the cooling assembly, and to an external environment. In some cases, the active heat dissipation causes the cooling assembly to feel cool to the touch for an extended period of time. This cool feeling can increase the comfort of garments that include the cooling assemblies.

As used herein, the term “textile” means, unless otherwise stated, any combination of fibers, including but not limited to woven, non-woven, or knitted. Non-limiting examples of textiles include fabrics and cloths. As used herein, the term “fiber” means, unless otherwise stated, any natural or synthetic polymer suitable for producing textiles. As used herein, “foam” means a solid organic material with pockets of gas trapped inside. Typically, the foam is a polymer, but in some examples the solid need not be a polymer. In any case, however, the term “foam” as used herein does not include metal foam. As used herein, the term “leather” means, unless otherwise stated, any material derived from animal rawhide or a synthetic equivalent/imitation.

As one non-limiting example, an assembly described herein may be incorporated into protective garments, such as body armor: health or safety equipment, such as braces, supports, or immobilizing devices: athletic equipment, such as weighted vests, helmets, pads, and footwear; and other specialty or performance apparel.

A multilayer cooling assembly described herein includes at least two compressible layers and at least one heat-dissipating layer, where each heat-dissipating layer is between two of the compressible layers. The compressible layers can include a textile, fabric, foam, leather, vinyl, plastic, rubber, or latex. Optionally, the compressible layer can be a combination of two or more of the foregoing materials. In some examples, at least one of the compressible layers is a textile layer. In more specific examples, the two compressible layers on either side of the heat-dissipating layer are both textiles. In alternative examples, one or both of the two compressible layers is a foam. The multilayer cooling assembly can include one or more compressible layers on one side of a heat-dissipating layer and can include one or more compressible layers on the opposite side of the heat-dissipating layer. In any assembly described herein, adjacent layers can be secured together by an adhesive. Optionally however, any two layers or all of the layers may be unsecured.

Optionally, a PCM is included in or on at least one of the compressible layers. For example, a PCM can be included in or on the compressible layer intended to contact (or be closest to) a wearer when the assembly is in use. The PCM enhances the heat absorption and dissipation provided by the heat-dissipating layer.

Phase change materials are capable of storing and releasing large amounts of energy as they change from one phase of matter to another. The PCMs described herein are encapsulated to form microencapsulated PCMs (“mPCMs”). Heat is absorbed when the material changes from solid to liquid, and heat is released when the material changes from liquid to solid. In some examples, PCMs useful in the formulations and treated substrates described herein have a melting point of 10 to 90° C. (e.g., 27° C. to 37° C., 27° C. to 32° C., or 27° C. to 29° C.). In other examples, useful PCMs have a melting point in a desired operating temperature range, which may vary depending on the end use of the treated substrate. The PCMs described herein have a heat of fusion of at least 100 J/g, as measured by ASTM D3418-12e1. The PCMs optionally have a heat of fusion of 170-200 J/g, as measured by ASTM D3418-12e1. When applied to textiles or other compressible materials used herein, certain mPCMs provide improved thermal management properties to the final product.

Including mPCM can increase comfort to the individual by providing a cool-to-the-touch effect. Any mPCM capable of being applied to a fiber, textile, or foam and undergoing a phase change due to heat from a wearer or user can be used in the thermal management formulations described herein. In some embodiments, mPCMs useful in the multilayer cooling assemblies include those where the PCM includes a salt hydrate: fatty acid or derivative thereof (e.g., fatty ester, fatty alcohol, and/or fatty amine); or an alkane (e.g., various oleochemicals and/or paraffins). Optionally, the PCM is an alkane having 12 to 20 carbon atoms, such as dodecane, tetradecane, hexadecane, octadecane, or eicosane. The PCM can be derived from a plant, animal, or petroleum source. The PCM can be derived from a biorenewable source.

In some examples, the microencapsulation coating on the mPCM may be an acrylic, polyurea, polyurethane, melamine-formaldehyde, or other coating. Coatings on PCMs, such as melamine-formaldehyde coatings, prevent the PCM from dispersing when it melts and thereby contributes to the durability of the mPCM treatment on the substrate. Moreover, combining the mPCM with a binder such as polyurethane and/or acrylic (polyacrylate) can significantly improve the wash durability of a mPCM-treated fiber, textile, or foam. In some examples, the mPCM can include a microencapsulated oleochemical. In some examples, the mPCM can include a microencapsulated octadecane.

The multilayer cooling assemblies described herein are suitable for use in protective garments, athletic equipment, performance apparel, and other clothing that contacts a wearer (directly or indirectly). Thus, the multilayer cooling assemblies include a wearer-facing surface. In some embodiments, the wearer-facing surface is an external surface of a compressible layer that actually contacts a wearer. In alternative embodiments, the cooling assembly may be combined with a separate layer or cover that actually contacts the wearer, for example, to protect the cooling assembly and/or to provide increased comfort, and thus the wearer-facing surface need not directly contact a wearer, but can be an external surface of the compressible layer that is closest to the wearer (i.e., closer to the wearer than any other external surface of any part of the cooling assembly) when the cooling assembly is in use.

For ease of reference, in some instances herein the assemblies and garments into which they are incorporated are described in the context of a body armor vest. That description is not intended to be limiting, and persons skilled in the art will understand how to adjust an assembly (if necessary) for use with a different type of garment.

Body armor is protective clothing used primarily by security personnel, such as military, police, security guards, and bodyguards, to absorb or deflect physical attacks. Body armor often includes metallic or ceramic plates and/or multiple layers of tightly woven high strength aramid fibers. Despite advances in materials, effective body armor is very heavy and has insulating properties that trap body heat and increase the risk of dehydration, heat stroke, and performance loss for those who wear it. The multilayer cooling assemblies described herein can be incorporated into body armor to improve personal thermal management of the wearer. For example, the multilayer cooling assemblies can be incorporated into a body armor vest as a cooling liner.

In addition to body armor, the multilayer cooling assemblies described herein can be incorporated into weighted vests (or other weighted garments) used as exercise accessories, in treating sensory processing disorders, or for any purpose.

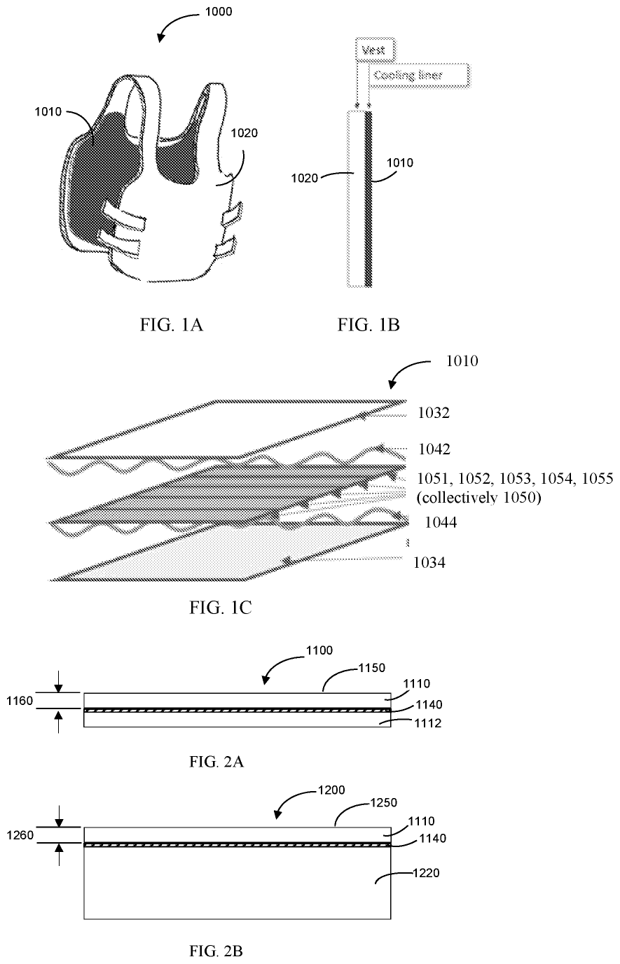

FIGS. 1A-1C are schematic representations of a garment 1000 that includes a multilayer cooling assembly 1010 consistent with the present disclosure. FIG. 1A is a perspective view of the garment 1000, in which the multilayer cooling assembly 1010 is located on the inside of a vest 1020, such as a body armor vest or a weighted exercise vest. The multilayer cooling assembly 1010 functions as a cooling liner for the vest 1020. FIG. 1B is a cross-sectional view of the vest 1020 and multilayer cooling assembly/cooling liner 1010. FIG. 1C is an exploded perspective view of the multilayer cooling assembly/cooling liner 1010, which includes textile layers 1032, 1034, adhesive layers 1042, 1044, and heat dissipating layer 1050. In FIG. 1C, heat dissipating layer 1050 is shown as multiple individual heat dissipating foil sheets 1051, 1052, 1053, 1054, 1055 that are aligned and in direct contact with one another to provide a continuous layer. In other examples, the heat dissipating layer 1050 could be a single continuous layer.

Incorporating the cooling liner 1010 shown in FIGS. 1A-IC does not require modification of the vest 1020 construction. The cooling liner 1010 can be simply laminated directly to an existing vest 1020. The cooling liner 1010 then acts as an intermediary layer between the vest 1020 and the wearer (not shown).

FIGS. 2A-2B are schematic representations of cross-sectional views of various examples of multilayer cooling assemblies consistent with the present disclosure. In FIG. 2A, a multilayer cooling assembly 1100 includes, from top to bottom, a first textile layer 1110, a heat-dissipating layer 1140, and a second textile layer 1112. Optionally, the heat-dissipating layer can be secured to one or both of the adjacent textile layers 1110, 1112 by an adhesive (not shown). The top layer of FIG. 2B, the textile layer 1110, is intended to be positioned closest to a wearer and optionally contacts the wearer, so the top surface 1150 of textile layer 1110 is the wearer-facing surface 1150 of the cooling assembly 1100. The heat-dissipating layer 1140 is separated from the wearer-facing surface 1150 by a partial thickness 1160 of the cooling assembly 1100. In alternative examples, the multilayer cooling assembly can include additional textile, leather, and/or foam layers in any position and on either side of the heat-dissipating layer and/or can have additional heat-dissipating layers in any position.

In FIG. 2B, a multilayer cooling assembly 1200 includes, from top to bottom, a textile layer 1110, a heat-dissipating layer 1140, and a foam layer 1220. Optionally, the heat-dissipating layer 1140 can be secured to the adjacent textile layer 1110 and/or the adjacent foam layer 1220 by an adhesive (not shown). The top layer of FIG. 2B, the textile layer 1110, is intended to be positioned closest to a wearer and optionally contacts the wearer, so the top surface 1250 of textile layer 1110 is the wearer-facing surface 1250 of the cooling assembly 1200. The heat-dissipating layer 1140 is separated from the wearer-facing surface 1150 by a partial thickness 1260 of the cooling assembly 1200. In alternative examples, the multilayer cooling assembly can include additional textile, leather, and/or foam layers in any position and on either side of the heat-dissipating layer and/or can have additional heat-dissipating layers in any position.

In any assembly described herein, the compressible layers generally provide cushioning and/or a soft feel to the cooling assembly, and the heat-dissipating layer can contribute to wearer-comfort by rapidly transporting the wearer's body heat, so the cooling assembly does not feel too warm and/or even feels cool to the touch. In some embodiments, the cooling assembly can feel cool to the touch for an extended period of time. However, if the materials in the cooling assembly are not selected and positioned properly, the heat-dissipating layer can adversely affect the flexibility and cushioning properties of the multilayer cushioning assembly. Thus, the compressible layers and the heat-dissipating layer must be selected and arranged to provide desired thermal properties as well as desired flexibility and cushioning.

When the cooling assembly is in use, the layer positioned closest to the wearer is a compressible layer, optionally a textile layer. That layer will include the wearer-facing surface of the cooling assembly, and the cooling assembly will have a partial thickness measured from the wearer-facing surface to the closest heat-dissipating layer. That partial thickness may be different for different assemblies, depending on type and position of layers in the cooling assembly, which depends on the desired end use of the cooling assembly. The heat-dissipating layer should be close enough to the wearer, or to the wearer-facing surface, to absorb the wearer's body heat, but not so close as to adversely affect the wearer's comfort. In some examples, a partial thickness of a multilayer cooling assembly measured from the wearer-facing surface to the closest heat-dissipating layer is from about 0.2 mm to about 200 mm, from about 10 mm to about 200 mm, from about 20 mm to about 200 mm, or from about 50 mm to about 200 mm. In other examples, a partial thickness of the multilayer cooling assembly measured from the wearer-facing surface to the closest heat-dissipating layer is from about 0.2 mm to about 100 mm, from about 0.2 mm to about 75 mm, from about 0.2 mm to 50 mm, from about 0.2 mm to about 70 mm, from about 0.2 mm to about 50 mm, from about 0.5 to about 50 mm, from about 1.0 mm to about 50 mm, from about 1.25 to about 50 mm.

In any assemblies described herein, the heat-dissipating layer includes a conductive foil, which is a very thin sheet of a conductive material. The conductive material can be metal-based, mineral-based, or carbon-based, as long as it is conductive. Conductive foil useful as a heat-dissipating layer in the cooling assemblies described herein has a thermal conductivity of at least 200 W/m-K, at least 300 W/m-K, at least 400 W/m-K, at least 500 W/m-K, at least 700 W/m-K, or at least 900 W/m-K . . . . In some examples, the conductive foil can have a thermal conductivity of 500 W/m-K to 1000 W/m-K, 900 W/m-K to 1500 W/m-K, 900 W/m-K to 2000 W/m-K, 900 W/m-K to 2500 W/m-K, or 900 W/m-K to 3000 W/m-K. The conductive foils described herein are inorganic materials. Examples of suitable conductive foils include, but are not limited to, metal foils, metal alloy foils, metal oxide foils, metal nitride foils, mineral-based foils, and carbon-based foils. In some embodiments, examples of suitable conductive foils include, but are not limited to foils formed from aluminum or its alloys, copper or its alloys, silver or its alloys, gold or its alloys, aluminum oxide, aluminum nitride, silicon carbide, and graphite.

In most examples, the conductive foils described herein are very thin sheets with a substantially homogenous composition throughout. As used herein, substantially homogeneous means compositionally consistent on a micron or greater scale. The conductive foils described herein do not include particulate-based coatings. As used herein, particulate-based coating refers to a heterogeneous mixture of thermally conductive particles in a matrix with lower thermal conductivity, such as a resin. The individual conductive particles are distinguishable within the material by common analytical methods. The thermally conductive particles provide many individual conductive surfaces of very small surface area (e.g., micron, or sub-micron sized): however, the less or non-conductive matrix limits the conductivity imparted to the compressible material by the particulate-based coating. In some embodiments, the conductive foil has a thickness of from about 10 μm to about 200 μm, from about 10 μm to about 125 μm, from about 10 μm to about 100 μm, from about 10 μm to about 75 μm, from about 10 μm to about 60 μm or from about 20 μm to about 75 μm, from about 20 μm to about 60 μm, or from about 20 μm to about 40 μm.

Optionally, the heat-dissipating layer further includes a protective coating that can, but need not necessarily, improve at least one mechanical property of the conductive foil. For example, a protective coating may increase the durability, tensile strength, tear resistance, and/or other desirable properties of a conductive foil. Optionally, the protective coating can be a polymeric coating, such as such as polyethylene terephthalate (PET), polyvinyl chloride (PVC), polyethylene (PE), polypropylene (PP), or a combination thereof. Optionally, the protective coating has a thickness of from about 5 μm to about 50 μm.

Additionally or alternatively, the heat-dissipating layer can be laminated, or otherwise secured, to an adjacent textile layer, and that textile layer can improve at least one mechanical property of the heat-dissipating layer. Optionally, the heat-dissipating layer (with or without a protective layer) is laminated to two adjacent textile layers, with one textile layer on each side of the heat-dissipating layer.

In some examples, the heat-dissipating layer is continuous. In most examples, the other compressible layers are continuous, but they need not necessarily be continuous. As used herein to describe the layers, “continuous” means the layer is substantially intact across its length and width (or analogous dimensions for a non-rectangular film). That is, a continuous layer has no intentional cuts, holes, tears, or other openings that extend through the thickness of the layer, from one surface to the opposing surface, where the thickness is the shortest dimension of the layer. A layer that includes minor defects, is considered substantially intact and “continuous” as that term is used herein to describe layers. An example of a continuous layer is one in which any 2 points on a surface the layer have an un-interrupted connection across a straight line from one point to the other.

In alternative examples, the heat-dissipating layer is semi-continuous. As used herein to describe the layers, “semi-continuous” means the layer has some openings (cuts, tears, holes, or other voids) that extend through the entire thickness of the film from one surface to the opposing surface, but none of those openings also extend through the entire width or the entire length of the thermally conductive film. An example of a semi-continuous layer is one in which any 2 points on a surface of the layer have an un-interrupted connection from one point to the other, but that connection may not be a straight line. In some embodiments, a semi-continuous film has a surface area of not less than 50 mm², e.g., not less than 500 mm², not less than 1000 mm², not less than 10,000 mm², not less than 100,000 mm², not less than 500,000 mm², not less than 1,000,0000 mm², or not less than 4,000,000 mm².

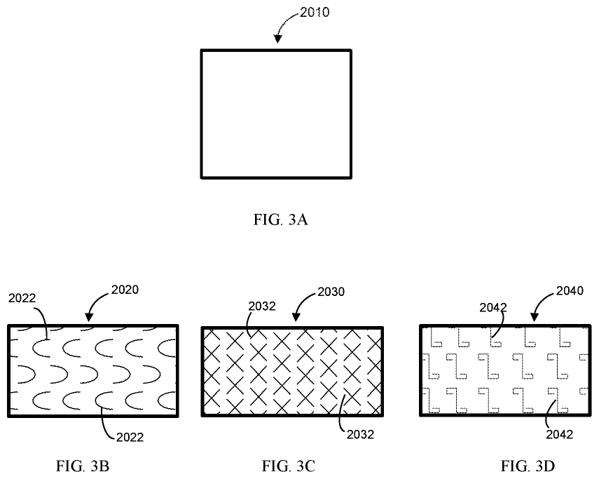

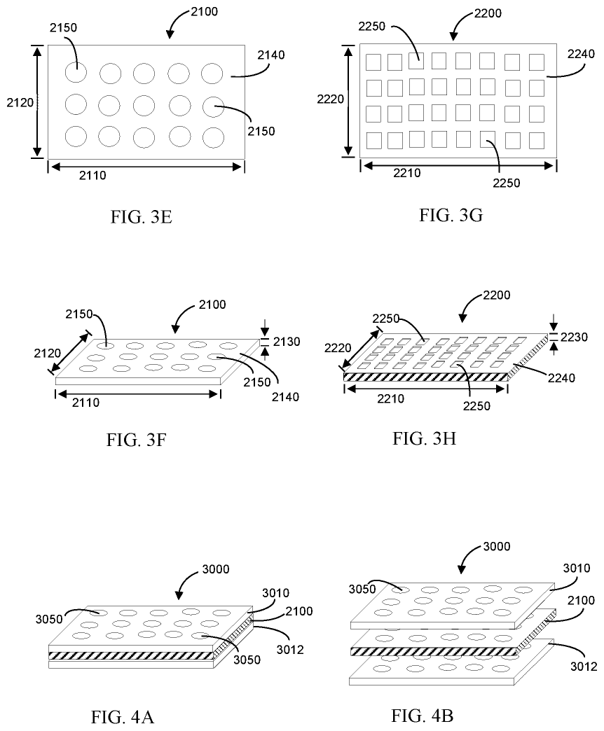

FIGS. 3A-3H are schematic representations of various examples of heat-dissipating layers described herein. FIG. 3A is a top view of a continuous heat-dissipating layer 2010, with no cuts or voids. FIGS. 3B, 3C, and 3D are top views of semi-continuous heat-dissipating layers 2020, 2030, 2040 with voids 2022, 2032, 2042 through the thickness of the layers 2020, 2030, 2040.

FIG. 3E is a top view and FIG. 3F is a perspective view of a continuous heat-dissipating layer 2100, with a length 2110, a width 2120, a thickness 2130, a semi-continuous surface 2140, and a plurality of circular openings 2150 through the thickness 2130 of the layer 2100. FIG. 3G is a top view and FIG. 3H is a perspective view of a semi-continuous heat-dissipating layer 2200, with a length 2210, a width 2220, a thickness 2230, a semi-continuous surface 2240, and a plurality of rectangular perforations 2250 through the thickness 2230 of the layer 2200.

When a semi-continuous heat-dissipating layer includes a protective coating, the openings through the heat-dissipating layer extend through both the conductive foil and the protective coating. When a semi-continuous heat-dissipating layer is laminated to one or two adjacent textile layers, the adjacent textile layer on one or both sides of the heat-dissipating layer can be continuous or can have one or more openings coextensive with the openings through the semi-continuous heat-dissipating layer. In some examples, each opening in the heat-dissipating layer also extends through the adjacent textile layer(s). In some examples, the heat-dissipating layer is laminated to the adjacent textile layer(s) while both are intact, and the layers are perforated at the same time.

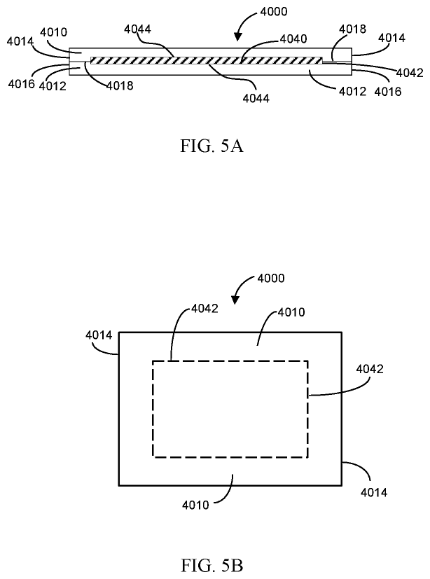

FIG. 4A is a perspective view and FIG. 4B is an exploded perspective view of an assembly 3000 with a semi-continuous, heat-dissipating layer 2300 laminated between two textile layers 1010, 1012, and a plurality of circular perforations 3050 through the heat-dissipating layer 2300 and through both textile layers 1010, 1012.

In some examples, a semi-continuous film can include holes ranging in size from about 0.1 mm to about 100 mm diameter, e.g., about 0.1 mm to about 80 mm, about 0.1 mm to about 60 mm, about 0.1 mm to about 40 mm, about 0.1 to about 20 mm, about 0.5 mm to about 20 mm, about 1 mm to about 20 mm, about 10 mm to about 20 mm, about 10 mm to about 40 mm, about 10 mm to about 60 mm, about 10 mm to about 80 mm, about 10 mm to about 100 mm, about 25 mm to about 100 mm, about 25 mm to about 75 mm, about 25 mm to about 50 mm. Optionally, the openings through a semi-continuous heat-dissipating layer can be any shape, such as circles, lines, curves, or spirals: letters or words: pictures: a pattern of repeating shapes, such as stripes: or a combination thereof.

When a heat-dissipating layer is semi-continuous the surface substantially perpendicular to the thickness includes solid areas and open areas. In some examples, The holes or other openings in the semi-continuous layer collectively provide a total open area that is up to 70% of the surface area of an identical layer without holes, e.g., up to 5%, up to 10%, up to 15%, up to 20%, up to 25%, up to 30%, up to 35%, up to 40%, up to 45%, up to 50%, up to 55%, up to 60%, up to 65%, or up to 70%. In some examples, the holes or other openings in the semi-continuous layer provide a total open area that is from about 5% to about 70% of the surface area of an identical layer without holes, e.g., from about 5% to about 65%, about 5% to about 60%, about 5% to about 55%, about 5% to about 50%, about 5% to about 45%, or about 5% to about 40%.

As an alternative to describing the semi-continuous layer in terms of percent open area, the semi-continuous layer can be described by its percent solid surface area, or “percent continuity.” The terms “percent continuity” and “percent continuous” are used herein to describe the ratio of the solid surface area of a semi-continuous layer to the surface area if the same layer were continuous. The surface area of the semi-continuous layer (SA_{sc}) is equal to the surface area if the layer were continuous, less the surface area displaced by the openings (SAₒ).

$${SA}_{sc} = {SA}_{cont .} - {SA}_{o}$$

As one non-limiting example, a rectangular semi-continuous, heat-dissipating layer of length l, width w, and n circular openings of radius r through the layer, would have a surface area, SA_{sc}, of

$${SA}_{sc} = lw - n π {r}^{2} .$$

The same layer would have a percent continuity equal to the ratio of SA_{sc} to SA_{cont}.

$$\% Continuity = \frac{{SA}_{sc}}{{SA}_{cont .}} \times 100 = \frac{lw - n π {r}^{2}}{lw} \times 100$$

In some examples, a semi-continuous, heat-dissipating layer has a percent continuity (percent solid surface area) of at least 30%, at least 35%, at least 40%, at least 45%, at least 50%, at least 55%, at least 60%, at least 65%, at least 70% at least 75%, at least 80%, at least 85%, at least 90%, at least 95%, or at least 99%. Optionally, the semi-continuous, heat-dissipating layer has a percent continuity of from about 30% to about 90%, e.g, from about 35% to about 90%, from about 40% to about 90%, from about 45% to about 90%, from about 50% to about 90%, from about 50% to about 85%, from about 50% to about 80%.

The dimensions of the cooling assembly and of each layer will vary depending upon the intended use of the final product. The various layers within the cooling assembly can be coextensive, i.e., they can have the same peripheral shape and can be superposed, but in some examples they need not be coextensive. The surface area of adjacent layers can vary by 1%, 5%, 10%, or more. In some examples, the heat-dissipating layer has substantially the same peripheral shape and dimensions as the wearer-facing surface. In some examples, the heat-dissipating layer has an area within its external periphery (equivalent to the surface area of a continuous layer) that is at least 50% of the size of the surface area of the wearer facing surface, e.g., at least 60%, at least 75%, at least 80%, at least 85%, at least, 90%, at least 95%, at least 99%, or substantially 100%. Representative dimensions for the surface in contact with the wearer will range from 50 mm² up to 4,000,000 mm² (4 m²). The thickness of the cooling assembly will range from 1.5 mm to 500 mm. The dimensions of adjacent layers within the cooling assembly may be the same, but need not be the same.

In any assembly disclosed herein, the compressible layers are selected from textile layers, leather layers, and/or foam layers. Textiles suitable for use in any multilayer cooling assembly described herein can be woven, non-woven, or knitted and can include plant fibers (e.g., ramie or linen), cellulosic fibers (e.g., cotton, bamboo, or hemp): synthetic fibers (e.g., polyester, nylon, rayon, or polyolefin), animal-derived fibers (e.g., wool or silk), glass fibers, any other known fibers, or combinations thereof. In some examples, a textile layer comprises cotton, linen, rayon, polyester, polyethylene, polypropylene, nylon, or a combination thereof. Optionally, a textile layer includes a flame resistant textile or a textile including flame resistant fibers, such as glass fibers or FR cotton/natural fibers. In some examples, a textile layer is a mattress ticking fabric. In some assemblies described herein

Polymeric foams are suitable for use in the multilayer cooling assemblies described herein. Examples of suitable polymeric foams include but are not limited to polyurethane foams, polyacrylic foams, and/or latex foams, such as those typically used in mattress assemblies. The term “foam” as used herein does not include metal foam.

Optionally, any layer of the multilayer cooling assembly can be secured to an adjacent layer with an adhesive. In some examples, the adhesive is a pressure sensitive adhesive. Optionally, the adhesive can be an acrylic-based adhesive, a rubber-based adhesive, or a silicone-based adhesive. Alternatively, two non-adjacent layers can be secured together around part of all of their perimeters if the non-adjacent layers are larger than an intervening adjacent layer. The intermediate layer can be secured to one or both of the adjacent layers, but it need not be. As an example, if a heat-dissipating layer is smaller than two compressible layers on either side of the heat-dissipating layer, the two compressible layers can be secured together outside of at least a portion of the perimeter of the heat-dissipating layer.

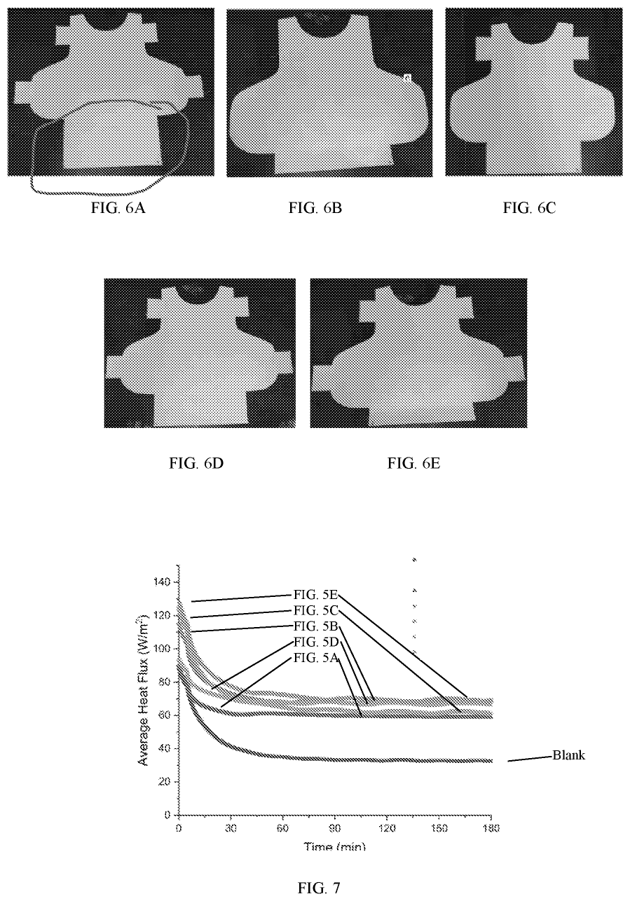

FIG. 5A is a schematic representation of a cross-sectional view of a multilayer cooling assembly 4000 described herein, and FIG. 5B is a schematic representation of a top view of the same multilayer cooling assembly 4000. The multilayer cooling assembly 4000 has a heat-dissipating layer 4040 between two textile layers 4010, 4012. The heat-dissipating layer 4040 has a perimeter 4042 that is inside the perimeters 4014, 4016 of the two textile layers 4010, 4012 so the two textile layers 4010, 4012 contact the heat-dissipating layer 4040 at interfaces 4044 and contact each other at interface 4018. Optionally, an adhesive (not shown) can bond one or both of the textile layers 4010, 4012 to the heat-dissipating layer 4040 at interface 4044 and/or can bond the two textile layers 4010, 4012 together at interface 4018.

The multilayer cooling assemblies described herein have increased heat flux as compared to an equivalent assembly that lacks the heat-dissipating layer or layers. The heat flux is defined as a flow of energy per unit of area per unit of time. Unless stated otherwise, the heat flux values identified herein are determined according to ANSI/RESNA SS-1 Section 4: Standard Protocol for Measuring Heat and Moisture Dissipation Characteristics of Full Body Support Surfaces—Sweating Guarded Hot Plate (SGHP) Method (2014). The cooling assemblies described herein and equivalent assemblies lacking a heat-dissipating layer have heat fluxes that inherently decrease over time from an initial heat flux to a steady state heat flux. The initial heat flux is the heat flux at the time heat is applied to the wearer-facing surface. The steady state heat flux is achieved when the heat flux does not change or is substantially constant over time. As used herein to describe heat flux, steady state means the heat flux changes by less than 3 W/m² over a 60 minute period.

In some examples, the multilayer cooling assemblies described herein have a steady state heat flux that is greater than a comparative assembly that is equivalent, but that lacks any thermally-conductive film. For example, the multilayer cooling assemblies described herein can have a steady state heat flux that is greater than the comparative assembly by about 25%, by about 50%, by about 100%, by about 150%, or by about 200%. In some embodiments, the multilayer cooling assemblies described herein have a steady state heat flux of at least 15 W/m², at least 20 W/m², at least 25 W/m², at least 30 W/m², at least 35 W/m², or at least 40 W/m².

### EXAMPLES

The multilayer cooling assemblies described herein rapidly diffuse body heat across a large surface area and promote body heat dissipation into the environment. Because this rate of heat diffusion is much higher in systems containing this thermally conductive layer than in those without (or in those with a non-contiguous coating), that difference can be easily measured and converted to an increase in heat transfer away from the heat source. This increased rate of heat transfer can be measured as heat flux. Product performance was measured by Integrated Thermal Sacrum (ITS) according to the method detailed in ASTM/RESNA SS-1 sec.

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the subject matter described herein which are apparent to one skilled in the art.

Heat flux data reported herein was measured according to ANSI/RESNA SS-1 Section 4: Standard Protocol for Measuring Heat and Moisture Dissipation Characteristics of Full Body Support Surfaces-Sweating Guarded Hot Plate (SGHP) Method (2014).

Multiple designs of the cooling assembly were utilized in the testing to determine the impact of the liner design with minimal variation observed. FIGS. 6A-6E show cooling liner designs tested. The extra rectangular section circled in FIG. 6A was found to be significantly impactful on the cooling performance. This section acts as a “radiator” that is not in direct contact with the wearer of the vest which helps to release heat into the environment.

Each cooling assembly tested herein included two 90 gsm polyester fabrics with one on each side of the heat-dissipating layer. One of the two fabrics has a PCM treatment applied to it. The heat-dissipating layer is a 25 micron thick synthetic graphite film. The textile layers were laminated to the heat-dissipating layer as shown in FIG. 1C using an acrylic adhesive.

FIG. 7 is a graph showing the heat flux of the designs shown in FIGS. 6A-5E. As shown in FIG. 7, the cooling assemblies increase the rate of heat flow away from the wearer which can help reduce thermal stress on the wearer.

Four key drivers in the performance of these conductive layers are the size of the radiator panel, PCM integration onto the textile laminate, thermal conductivity of the conductive layer, and thickness of the conductive layer.

1. A multilayer cooling assembly comprising at least two compressible layers and at least one heat-dissipating layer comprising a conductive foil, wherein each heat-dissipating layer is between two of the at least two compressible layers, and wherein each compressible layer is independently selected from a textile layer, a leather layer, and a foam layer, optionally wherein at least one of the at least two compressible layers is a textile layer or a foam layer.

2. The multilayer cooling assembly of claim 1, wherein the at least two compressible layers comprise first and second textile layers, and wherein the heat-dissipating layer is between and adjacent to the first and second textile layers

3. The multilayer cooling assembly of claim 2, wherein the at least two compressible layers further comprise a foam layer.

4. The multilayer cooling assembly of claim 1, wherein the at least two compressible layers comprise a textile layer and a foam layer, and wherein the heat-dissipating layer is between and adjacent to the textile layer and the foam layer.

5. The multilayer cooling assembly of claim 4, wherein the textile layer is a first textile layer, and wherein the at least two compressible layers further comprise a second textile layer.

6. The multilayer cooling assembly of claim 1, wherein at least one of the compressible layers comprises a microencapsulated phase change material.

7. The multilayer cooling assembly of claim 1, wherein the at least two compressible layers are secured to the heat-dissipating layer with an adhesive, such as a vinyl adhesive.

8. The multilayer cooling assembly of claim 1, wherein the conductive foil is a continuous layer.

9. The multilayer cooling assembly of claim 1, wherein the conductive foil is inorganic.

10. The multilayer cooling assembly of claim 1, wherein the conductive foil has a thermal conductivity of at least 200 W/m-K.

11. The multilayer cooling assembly of claim 1, wherein the conductive foil comprises a metal, a metal alloy, a metal oxide, a metal nitride, a mineral, a carbon-based material, or a combination thereof.

12. The multilayer cooling assembly of claim 1, wherein the conductive foil comprises aluminum, an aluminum alloy, copper, a copper alloy, silver, a silver alloy, gold, a gold alloy, aluminum oxide, aluminum nitride, silicon carbide, graphite, or a combination thereof.

13. The multilayer cooling assembly of claim 1, wherein the conductive foil comprises a thickness from about 10 μm to about 200 μm.

14. The multilayer cooling assembly of claim 1, wherein the heat-dissipating layer further comprises a protective coating.

15. The multilayer cooling assembly of claim 1, wherein the heat-dissipating layer is not particulate-based.

16. The multilayer cooling assembly of claim 1, wherein at least one of the at least two compressible layers, comprises a textile, and wherein the textile comprises fibers comprising cotton, linen, rayon, polyester, polyethylene, polypropylene, nylon, glass fibers or FR cotton/natural fibers, or a combination thereof.

17. The multilayer cooling assembly of claim 1, wherein at least one compressible layer comprises a flame resistant textile.

18. The multilayer cooling assembly of claim 1, further comprising a wearer-facing surface and a partial thickness measured from the wearer-facing surface to the heat-dissipating layer, wherein the thickness is from about 0.5 mm to 200 mm.

19. The multilayer cooling assembly of claim 1, comprising at least two heat-dissipating layers.

20. The multilayer cooling assembly of claim 1, comprising at least three heat-dissipating layers.

21. The multilayer cooling assembly of claim 1, comprising a steady state heat flux of at least 15 W/m².

22. The multilayer cooling assembly of claim 1, comprising a steady state heat flux about 25% greater than a steady state heat flux of a comparative assembly that is equivalent to the multilayer cooling assembly but lacks any heat-dissipating layer.

23. The multilayer cooling assembly of claim 22, wherein the heat flux of the multilayer cooling assembly is greater than 15 W/m².

24. A garment comprising a cooling layer comprising the multilayer cooling assembly of claim 1.

25. The garment of claim 24, wherein the garment is a body armor vest, a weighted exercise vest, or a weighted therapeutic vest.
